(19) United States
(12) Patent Application Publication
(10) Pub. No.: US 2010/0144910 A1
(43) Pub. Date: Jun. 10, 2010

(54) PROCESS TO PRODUCE POLYMERS

(75) Inventors: Max P. McDaniel, Bartlesville, OK (US); Elizabeth A. Benham, Spring, TX (US); Al R. Wolfe, Bartlesville, OK (US)

Correspondence Address: FLETCHER YODER (CHEVRON PHILLIPS), P. O. BOX 692289, HOUSTON, TX, 77069, US

(73) Assignee: Chevron Phillips Chemical Company LP, The Woodlands, TX (US)

(21) Appl. No.: 12/704,425

(22) Filed: Feb. 11, 2010

Related U.S. Application Data
(62) Division of application No. 11/032,379, filed on Jan. 10, 2005.

(51) Int. Cl. B01J 39/20; C08F 4/06; C08F 4/44; C08F 2/01

(52) U.S. Cl. 521/38; 526/113; 526/114; 526/64

(57) ABSTRACT

Catalyst systems for producing olefin polymers, methods of making such catalyst systems, and processes for producing olefin polymers using such catalyst systems are provided. The catalyst system comprises a first component and a second component, where the first component comprises chromium on a support, where the support comprises phosphated alumina, and the second component comprises: (1) a metal halide compound, a transition metal compound, and a precipitating agent, or (2) a substituted or unsubstituted dicyclopentadienyl chromium compound deposited onto a calcined oxide carrier, where the carrier includes silica, alumina, aluminophosphate, or any mixed oxide thereof.

### RELATED APPLICATIONS

This application claims the benefit under 35 U.S.C. §121 of U.S. application Ser. No. 11/032,379 filed on Jan. 10, 2005, which is incorporated herein by reference in its entirety.

### FIELD OF THE INVENTION

This invention is related to the field of processes for producing polymers, for example, ethylene polymers.

### BACKGROUND OF THE INVENTION

There are many production processes that produce ethylene polymers. Ethylene polymers are utilized in many products, such as, for example, films, coatings, fibers, and pipe. Manufacturers of such ethylene polymers are continuously conducting research to find improved ethylene polymers. This invention provides catalyst systems that may be used to form ethylene polymers with improved properties, including homopolymers of ethylene and copolymers of ethylene with another monomer, and ethylene polymers formed therefrom.

### BRIEF DESCRIPTION OF THE DRAWINGS

FIG. 1 is a plot depicting the MW distribution and short chain branching for the polymers of Example 2.

### SUMMARY OF THE INVENTION

The present invention generally relates to catalyst systems for producing olefin polymers, methods of making such catalyst systems, and processes for producing olefin polymers using such catalyst systems. According to one aspect of the present invention, a catalyst system comprises a first component and a second component. The first component comprises chromium on a support, where the support comprises phosphated alumina. The second component comprises either:

(1) the contact product of:
i) a metal halide compound, wherein the metal halide compound is a metal dihalide compound or a metal hydroxyhalide compound of a Group IIA or Group IIB metal of the Mendeleev Periodic Table;
ii) a transition metal compound, wherein the transition metal compound comprises a transition metal of Group IVB or Group VB of the Mendeleev Periodic Table, and wherein the transition metal compound comprises at least one hydrocarbyl oxide ligand, at least one hydrocarbyl amide ligand, at least one hydrocarbyl imide ligand, or at least one hydrocarbyl thiolate ligand; and
iii) a precipitating agent, wherein the precipitating agent is an organometallic compound of a Group I, II, or III metal of the Mendeleev Periodic Table; a metal halide or a metal oxyhalide of a Group IIIA, IVA, IVB, VA, or VB metal of the Mendeleev Periodic Table; a hydrogen halide; or an organic acid halide RC(O)X, wherein R is an alkyl, an aryl, a cycloalkyl, or a combination thereof having from 1 to about 12 carbon atoms, and X is a halogen atom; or

(2) a substituted or unsubstituted dicyclopentadienyl chromium compound deposited onto a calcined oxide carrier, wherein the carrier comprises silica, alumina, aluminophosphate, or any mixture or mixed oxide thereof.

The present invention also contemplates a process for forming a catalyst composition. The process comprises contacting a first component and a second component. The first component comprises chromium on a support, where the support comprises phosphated alumina. The second component comprises either:

(1) the contact product of:
i) a metal halide compound, wherein the metal halide compound is a metal dihalide compound or a metal hydroxyhalide compound of a Group IIA or Group IIB metal of the Mendeleev Periodic Table;
ii) a transition metal compound, wherein the transition metal compound comprises a transition metal of Group IVB or Group VB of the Mendeleev Periodic Table, and wherein the transition metal compound comprises at least one hydrocarbyl oxide ligand, at least one hydrocarbyl amide ligand, at least one hydrocarbyl imide ligand, or at least one hydrocarbyl thiolate ligand; and
iii) a precipitating agent, wherein the precipitating agent is an organometallic compound of a Group I, II, or III metal of the Mendeleev Periodic Table; a metal halide or a metal oxyhalide of a Group IIIA, IVA, IVB, VA, or VB metal of the Mendeleev Periodic Table; a hydrogen halide; or an organic acid halide RC(O)X, wherein R is an alkyl, an aryl, a cycloalkyl, or a combination thereof having from 1 to about 12 carbon atoms, and X is a halogen atom; or

(2) a substituted or unsubstituted dicyclopentadienyl chromium compound deposited onto a calcined oxide carrier, wherein the carrier comprises silica, alumina, aluminophosphate, or any mixture or mixed oxide thereof.

The present invention further contemplates a process for polymerizing olefins in the presence of a catalyst composition. The process comprises contacting the catalyst composition with at least one type of olefin monomer under polymerization conditions to produce a polymer. The catalyst composition comprises:

a) a first component comprising chromium on a support, wherein the support comprises phosphated alumina; and

b) a second component comprising either:
(1) the contact product of:
   i) a metal halide compound, wherein the metal halide compound is a metal dihalide compound or a metal hydroxyhalide compound of a Group IIA or Group IIB metal of the Mendeleev Periodic Table;
   ii) a transition metal compound, wherein the transition metal compound comprises a transition metal of Group IVB or Group VB of the Mendeleev Periodic Table, and wherein the transition metal compound comprises at least one hydrocarbyl oxide ligand, at least one hydrocarbyl amide ligand, at least one hydrocarbyl imide ligand, or at least one hydrocarbyl thiolate ligand; and
   iii) a precipitating agent, wherein the precipitating agent is an organometallic compound of a Group I, II, or III metal of the Mendeleev Periodic Table; a metal halide or a metal oxyhalide of a Group IIIA, IVA, IVB, VA, or VB metal of the Mendeleev Periodic Table; a hydrogen halide; or an organic acid halide RC(O)X, wherein R is an alkyl, an aryl, a cycloalkyl, or a combination thereof having from 1 to about 12 carbon atoms, and X is a halogen atom; or
(2) a substituted or unsubstituted dicyclopentadienyl chromium compound deposited onto a calcined oxide carrier, wherein the carrier comprises silica, alumina, aluminophosphate, or any mixture or mixed oxide thereof.

### DETAILED DESCRIPTION OF THE INVENTION

A process comprising blending a first component and a second component to produce a catalyst system is provided. The blending may be accomplished by any means known to those skilled in the art. For example, the first component and the second component may be premixed prior to being utilized in a polymerization zone. Alternatively, the first and second component may be routed into a polymerization zone individually in specified portions. For example, the first and second components can be dry blended together in a mixer or added to a feed stream that leads to a reactor.

### A. The First Component

The first component of the catalyst system comprises chromium on a support. According to one aspect of the present invention, the chromium may be present in an amount of from about 0.05 to about 5 weight percent, based on the weight of the support. According to another aspect of the present invention, the chromium may be present in an amount of from about 0.1 to about 3 weight percent. According to still another aspect of the present invention, the chromium may be present in an amount of from about 0.8 to about 2.5 weight percent. The chromium may typically be in the form of chromium oxide after activation.

Various supports may be used in accordance with the present invention. The support may typically have a surface area from about 150 to about 700 m²/g. According to one aspect of the present invention, the support may have a surface area from about 200 to about 450 m²/g. According to another aspect of the present invention, the support may have a surface area from 250 to 400 m²/g.

The support may typically have a pore volume from about 0.7 to about 3.0 cm³/g. According to one aspect of the present invention, the support may have a pore volume from about 0.8 to about 1.8 cm³/g. According to another aspect of the present invention, the support may have pore volume from about 1.0 to about 1.7 cm³/g.

According to one aspect of the present invention, the support may comprise alumina. As used herein, “alumina” refers to any support substantially comprising Al₂O₃ after dehydration. Suitable alumina supports typically have a high surface area, for example, from about 150 to about 700 m²/g, a pore volume of from about 1.0 to about 2.0 cc/g, and a particle size distribution of from about 10 to about 500 microns. Many commercial sources of alumina supports are commercially available. Such commercial sources are often provided as alumina hydrates, such as boehmite or aluminum hydroxide. Such material also may contain a small amount of silica or other materials, providing they do not interfere with the polymerization process. Methods of producing alumina are known in the art. See, for example, U.S. Pat. Nos. 3,900,457, 4,081,407, 4,392,990, 4,405,501, 4,735,931, and 4,981,831, each of which is incorporated by reference herein in its entirety.

According to another aspect of the present invention, the support may comprise an aluminophosphate. The P/Al molar ratio of the aluminophosphate generally may be from about 0.03 to about 0.28. According to one aspect of the present invention, the P/Al molar ratio of the aluminophosphate may be from about 0.1 to about 0.25. According to another aspect of the present invention, the P/Al molar ratio of the aluminophosphate may be from about 0.15 to about 0.250.

Generally, the aluminophosphate support may be prepared by any method known in the art, such as, for example, use of a cogellation technique. Examples of preparations are provided in U.S. Pat. Nos. 4,364,842, 4,444,965, 4,364,855, 4,504,638, 4,364,854, 4,444,964, 4,444,962, 4,444,966, and 4,397,765, each of which is incorporated by reference herein in its entirety. According to one aspect of the present invention, the aluminophosphate support may be prepared from a cogel of an aluminum and phosphate compound. Such a cogel hydrogel may be produced by contacting an aluminum and phosphorus compound, usually with a small amount of water, and warming the mixture to about 40° C., or to a temperature sufficient to dissolve the mixture. A base, such as ammonium hydroxide, then may be added to cause precipitation or gellation. By varying the amounts of aluminum and phosphorus added, the desired P/Al molar ratio can be achieved.

Optionally, the alumina or aluminophosphate support may be contacted with a source of fluoride or sulfate in addition to chromium to form a “fluorided support” or a “sulfated support”. Treatment with a source of fluoride or sulfate may improve the activity of the catalyst or the melt index potential of the resulting polymer. Any organic or inorganic fluorine-containing compound that can form a fluoride ion with alumina may be used. Suitable fluorine-containing compounds include, but are not limited to, hydrofluoric acid (HF), ammonium fluoride (NH₄F), ammonium bifluoride (NH₄HF₂), ammonium fluoroborate (NH₄BF₄), ammonium silicofluoride ((NH₄)₂SiF₆), and mixtures thereof. Suitable sulfating agents include sulfuric acid, ammonium sulfate, aluminum sulfate, ammonium bisulfate, or sulfur compounds that can be converted to sulfate during calcining, such as SO₃, sulfides, or sulfites. If desired, the support may be calcined prior to being treated with fluoride or sulfate and/or chromium, for example, the support may be calcined in air at about 100° C. to about 900° C.

The fluorine-containing compound or the sulfur-containing compound may be contacted with the support during impregnation or during activation. According to one aspect of the present invention, the fluoride or sulfate may be added to the support by forming a slurry of the support in a solution of the fluoriding or sulfating agent and a solvent, such as alcohol or water. Other suitable solvents include one to three carbon atom alcohols because of their volatility and low surface tension. The concentration of the solution may be selected as needed to provide the desired concentration of fluoride or sulfate on the support. The fluorided or sulfated support may be dried using any technique known in the art including, but not limited to, suction filtration followed by evaporation, or drying under vacuum. According to another aspect of the present invention, the support may be fluorided by injection of fluorocarbons, such as perfluorohexane or freons, into the calcining gas during the calcining step. The fluorocarbons then decompose, leaving fluoride on the surface of the support. Likewise, the support can be sulfated during the calcining as well, for example, by adding SO₃ to the calcining gas.

The amount of fluoride on the support generally may be from about 1 to about 10 weight percent fluoride based on the weight of the support. According to one aspect of the present invention, the amount of fluoride on the support may be from about 3 to about 8 weight percent fluoride. The amount of sulfate on the support generally may be from about 1 to about 30 weight percent sulfate based on the weight of the support. According to one aspect of the present invention, the amount of sulfate on the support may be from about 5 to about 15 weight percent sulfate.

According to another aspect of the present invention, the alumina or aluminophosphate optionally may be contacted with a source of phosphate in addition to chromium. Treatment with a source of phosphate may improve the activity of the catalyst or the melt index potential of the resulting polymer. Any organic or inorganic phosphorus-containing compound that can form a phosphate ion with alumina during calcining may be used, such as phosphoric acid solutions, inorganic phosphate salts, and organic phosphate esters. Examples of phosphate-containing compounds that may be suitable for use with the present invention include, but are not limited to, H₃PO₄, NH₄H₂PO₄, (NH₄)₂HPO₄, H₃PO₃, and (OCH₃)₃P.

The phosphated support may be formed using various techniques. If desired, the support may be calcined prior to being treated with phosphate and/or chromium, for example, the support may be calcined in air at about 100° C. to about 900° C. The phosphate treatment may be done before, after, or during the calcining step.

According to one aspect of the present invention, the phosphate-containing compound may be contacted with the support during impregnation. For example, the support may be impregnated with an aqueous or organic solution of phosphoric acid, followed by drying. According to another aspect of the present invention, the support may be calcined, then impregnated with phosphoric acid and other desired materials, followed by a second calcining (or activation) step.

Typically, the phosphate may be added in an amount of from about 0.01 to about 0.3 equivalents of phosphorous per equivalent of aluminum in the support. According to one aspect of the present invention, the phosphate may be added in an amount of from about 0.01 to 0.2 equivalents of phosphorous per equivalent of aluminum in the support. According to another aspect of the present invention, phosphate may be added in an amount of from about 0.01 to 0.1 equivalents of phosphorous per equivalent of aluminum in the support. According to yet another aspect of the present invention, phosphate may be added in an amount of from about 0.01 to about 0.05 equivalents of phosphorous per equivalent of aluminum in the support.

According to another aspect of the present invention, the first component of the catalyst system is activated, or calcined, prior to introduction into the polymerization system. The first component typically may be activated in an oxidizing ambient such as oxygen gas or air to convert at least a portion of the chromium in a lower valance state to a hexavalent state. The first component generally may be activated at a temperature of from about 200° C. to about 1000° C. According to one aspect of the present invention, the first component may be activated at a temperature of from about 400° C. to about 800° C. According to another aspect of the present invention, the first component may be activated at a temperature of from about 500° C. to about 700° C. Activation times may vary from a few minutes to about 24 hours, for example, from about 3 to about 10 hours.

After being activated, the first component optionally may be reduced to convert at least a portion of the hexavalent chromium to a lower valence state. In general, the reduction may be carried out at a temperature of from about 200° C. to 500° C. According to one aspect of the present invention the reduction may be carried out at a temperature of from about 300° C. to about 400° C. The reduction may be conducted for a duration of from about 1 minute to about 24 hours. Carbon monoxide may be used in this reduction. After reduction, the first component may be flushed at an elevated temperature with nitrogen to remove the reducing agent.

### B. The Second Component

The second component of the catalyst system comprises either:

1) a transition metal halide catalyst comprising a metal halide compound and a transition metal compound including, but not limited to, the transition metal catalysts disclosed in U.S. Pat. No. 4,325,837, incorporated herein by reference in its entirety, combined with a precipitating agent; or

2) a dicyclopentadienyl chromium compound deposited onto an inorganic oxide support.

The metal halide compound typically may be a metal dihalide or a metal hydroxyhalide According to one aspect of the present invention, the metal may be a Group IIA or Group IIB metal of the Mendeleev Periodic Table, for example, beryllium, magnesium, calcium, or zinc. As used herein by the term “Mendeleev Periodic Table” is meant the Periodic Table of the Elements as shown in the inside front cover of Perry, Chemical Engineer's Handbook, 4th Edition, McGraw Hill & Co. (1963). Examples of metal halide compounds that may be suitable for the present invention include, but are not limited to, beryllium dichloride, beryllium dibromide, beryllium hydroxyiodide, magnesium dichloride, magnesium bromide, magnesium hydroxychloride, magnesium diiodide, magnesium difluoride, calcium dichloride, calcium dibromide, calcium hydroxybromide, zinc dichloride, zinc difluoride, and zinc hydroxychloride.

The transition metal of the transition metal compound typically may be a Group IVB or Group VB transition metal of the Mendeleev Periodic Table, such as, for example, titanium, zirconium, or vanadium. However, other transition metals may be employed and are contemplated by the present invention. The transition metal compound may comprise at least one hydrocarbyl oxide ligand, at least one hydrocarbyl amide ligand, at least one hydrocarbyl imide ligand, or at least one hydrocarbyl thiolate ligand. According to one aspect of the present invention, all of the ligands are the same. Some of the compounds that may be suitable for use with the present invention include, but are not limited to, titanium tetrahydrocarboxyloxides, titanium tetraalkoxides, titanium tetraimides, titanium tetraamides and titanium tetramercaptides.

Suitable titanium tetrahydrocarbyloxide compounds include those expressed by the general formula Ti(OR)₄, wherein each R is individually an alkyl, a cycloalkyl, an aryl, an alkaryl, and an aralkyl hydrocarbon radical containing from about 1 to about 20 carbon atoms per radical. Each R may be the same or different from other R groups. Titanium tetrahydrocarbyloxides in which each hydrocarbyl group contains from about 1 to about 10 carbon atoms per radical are employed frequently because they are readily available.

Examples of such titanium tetrahydrocarbyloxides include, but are not limited to, titanium tetramethoxide, titanium dimethoxydiethoxide, titanium tetraethoxide, titanium tetra-n-butoxide, titanium tetrahexyloxide, titanium tetradecyloxide, titanium tetraeicosyloxide, titanium tetracyclohexyloxide, titanium tetrabenzyloxide, titanium tetra-p-tolyloxide and titanium tetraphenoxide. Other transition metal compounds include, for example, zirconium tetrahydrocarbyloxides, zirconium tetraimides, zirconium tetraamides, zirconium tetramercaptides, vanadium tetrahydrocarbyloxides, vanadium tetraimides, vanadium tetraamides and vanadium tetramercaptides.

The molar ratio of the transition metal compound to the metal halide compound generally may be from about 10:1 to about 1:10. According to one aspect of the present invention, the molar ratio of the transition metal compound to the metal halide compound may be from about 3:1 to about 0.5:2. According to another aspect of the present invention, the molar ratio of the transition metal compound to the metal halide compound may be from about 2:1 to about 1:2. When titanium tetrahydrocarbyloxide and magnesium dichloride are employed, a molar ratio of titanium to magnesium of about 2:1 may be used to permit the magnesium compound to readily dissolve.

According to another aspect of the present invention, the contact product of the metal halide and the transition metal compound may be treated with a precipitating agent. The precipitating agent generally may be an organometallic compound in which the metal is a Group I, Group II, or Group III metal of the Mendeleev Periodic Table, a metal halide or an oxyhalide of a Group IIIA, IVA, IVB, VA, or VB element of the Mendeleev Periodic Table, a hydrogen halide, or an organic acid halide expressed as RC(O)X, wherein R is an alkyl, an aryl, a cycloalkyl, or a combination thereof having from 1 to about 12 carbon atoms, and X is a halogen atom.

Some organometallic compounds that may be suitable for use as the precipitating agent, in which the metal of the organometallic compound is selected from metals of Group I, Group II, or Group III of the Mendeleev Periodic Table, include, for example, lithium alkyls, Grignard reagents, dialkyl magnesium compounds, dialkyl zinc compounds, hydrocarbylaluminum halide compounds, and the like.

Examples of metal halides and oxygen-containing halides of elements selected from Groups IIIA, IVA, IVB, VA, and VB that may be suitable for use as the precipitating agent include, for example, aluminum tribromide, aluminum trichloride, aluminum triiodide, tin tetrabromide, tin tetrachloride, silicon tetrabromide, silicon tetrachloride, phosphorous oxychloride, phosphorous trichloride, phosphorous pentabromide, vanadium tetrachloride, vanadium oxytrichloride, vanadyl trichloride, zirconium tetrachloride, and the like.

Additional organoaluminum halide compounds that may be suitable comprise dihydrocarbylaluminum monohalides of the formula:

R′₂AlX,

monohydrocarbylaluminum dihalides of the formula:

R′AlX₂,

and hydrocarbylaluminum sesquihalides of the formula:

R′₃Al₂X₃.

In each of the above formulas, each R′ may be the same or different and may be a linear or branched chain hydrocarbyl radical containing from 1 to about 20 carbon atoms per radical. Further, each X may be the same or different and may be a halogen atom. Some examples of organoaluminum halide compounds that may be suitable with the present invention include, but are not limited to, methylaluminum dibromide, ethylaluminum dichloride, ethylaluminum diiodide, isobutylaluminum dichloride, dodecylaluminum dibromide, dimethylaluminum bromide, diethylaluminum chloride, diisopropylaluminum chloride, methyl-n-propylaluminum bromide, di-n-octylaluminum bromide, diphenylaluminum chloride, dicyclohexylaluminum bromide, dieicosylaluminum chloride, methylaluminum sesquibromide, ethylaluminum sesquichloride, and ethylaluminum sesquiiodide.

Examples of hydrogen halides that may be suitable for use as the precipitating agent include, for example, hydrogen chloride, hydrogen bromide, and the like.

Some organic acid halides that may be suitable for use as the precipitating agent include, for example, acetyl chloride, propionyl fluoride, dodecanoyl chloride, 3-cyclopentylpropionyl chloride, 2-naphthoyl chloride, benzoyl bromide, benzoyl chloride, and the like.

The molar ratio of the transition metal compound to the precipitating agent generally may be from about 10:1 to about 1:10. According to one aspect of the present invention, the molar ratio of the transition metal compound to the precipitating agent may be from about 2:1 to about 1:3. Such molar ratios have been shown to produce a highly active ethylene polymerization catalyst.

Optionally, the second component further may comprise an anti-caking agent. Generally, the anti-caking agent may comprise a fumed refractory oxide. The fumed refractory oxide may be fumed silica, fumed titanium dioxide, fumed alumina, any mixture thereof, or any mixed oxide thereof. A detailed discussion of fumed refractory oxide is provided in U.S. Pat. No. 5,179,178, herein incorporated by reference in its entirety. The anti-caking agent may be added to the second component of the catalyst system in an amount of from about 2 to about 20 weight percent based on the weight of the second component.

The metal halide compound and the transition metal compound typically may be mixed together by heating, e.g. refluxing, the components together in a suitable dry (essential absence of water) solvent or diluent that is inert to the components and the product produced. As used herein, “inert” means that the solvent does not chemically react with the dissolved components, and therefore does not interfere with the formation of the product or the stability of the product once it is formed. Examples of inert solvents or diluents may include, for example, n-pentane, n-hexane, n-heptane, methylcyclohexane, toluene, and xylenes. Aromatic solvents, for example, xylene, typically may be used because the solubility of the metal halide compound and the transition metal compound often is higher in aromatic solvents than in aliphatic solvents.

The catalyst component solution and the precipitating agent may be combined under an olefin atmosphere to form a prepolymer. The olefin atmosphere employed may be an aliphatic mono-1-olefin having from 2 to about 18 carbon atoms per molecule, for example, ethylene, propylene, 1-butene, 1-pentene, 1-hexene, 1-heptene, 1-octene, 1-nonene and 1-decene, or any mixture of one or more thereof.

According to yet another aspect of the present invention, the second component of the catalyst system of the present invention may be treated with a halide ion exchanging source, for example, a halide of a transition metal. Examples of some halide ion exchanging sources that may be suitable include, but are not limited to, titanium tetrahalides, such as titanium tetrachloride, vanadium oxychloride, and zirconium tetrachloride. It should be noted that the term “halide ion exchanging source” is used herein merely for convenience; it is not intended to limit the theory by which the action of such compounds may be explained. Rather, the present invention encompasses the compounds used regardless of the actual mechanism The solid catalyst component may be contacted with a halide ion exchanging source either before or after the prepolymerization step.

The second component alternatively may be a substituted or unsubstituted dicyclopentadienyl chromium compound deposited onto an oxide carrier. As used herein, “dicyclopentadienyl chromium compound” refers to a divalent chromium his (eta-5 C₅R₅) compound in which R can be hydrogen or an alkyl radical having 1 to about 10 carbon atoms. According to one aspect of the present invention, the compound is chromocene, Cr(C₅H₅)₂. This material may be deposited onto an inorganic oxide carrier in the amount of from about 0.1 wt % to about 3 wt %. The oxide carrier may be a silica, alumina, silica-alumina, silica-titania, an aluminophosphate, or any combination or any mixed oxide thereof, such as those described above. The carrier typically is calcined at a temperature of from about 300° C. to about 900° C. before the chromocene compound is added. The carrier optionally may be treated with fluoride or sulfate, as described above. It may be selected to be the same carrier as is used for the first component. Thus, the chromocene optionally may be deposited onto the first component, so that a single carrier contains both chromium oxide and chromocene components.

### C. Polymerization Process

The present invention further contemplates a process for polymerizing ethylene, or copolymerizing ethylene and at least one other monomer, to produce an ethylene polymer. The other monomer may comprise an olefin having from 4 to about 16 carbon atoms per molecule. Suitable monomers may include, but are not limited to, 1-butene, 1-pentene, 4-methyl-1 -pentene, 1-hexene, and 1-octene.

The polymerization may be carried out in a polymerization zone using any manner known in the art, such as gas phase, solution, or slurry polymerization. A stirred reactor may be used for a batch process, or a loop reactor may be used for a continuous process.

A typical polymerization method is a slurry polymerization process (also known as the particle form process), which is well known in the art and is disclosed, for example, in U.S. Pat. No. 3,248,179, incorporated by reference herein in its entirety. Other polymerization methods of the present invention for slurry processes are those employing a loop reactor of the type disclosed in U.S. Pat. No. 3,248,179, incorporated by reference herein in its entirety, and those utilized in a plurality of stirred reactors either in series, parallel, or combinations thereof, where the reaction conditions are different in the different reactors. Suitable diluents used in slurry polymerization are well known in the art and include hydrocarbons that are liquids under reaction conditions. The term “diluent” as used in this disclosure does not necessarily mean an inert material, as this term is meant to include compounds and compositions that may contribute to polymerization process. Examples of hydrocarbons that may be used as diluents include, but are not limited to, cyclohexane, isobutane, n-butane, propane, n-pentane, isopentane, neopentane, and n-hexane. Typically, isobutane may be used as the diluent in a slurry polymerization, as provided by U.S. Pat. Nos. 4,424,341, 4,501,885, 4,613,484, 4,737,280, and 5,597,892, each of which is incorporated by reference herein in its entirety.

Various polymerization reactors are contemplated by the present invention. As used herein, “polymerization reactor” includes any polymerization reactor or polymerization reactor system capable of polymerizing olefin monomers to produce homopolymers or copolymers of the present invention. Such reactors may be slurry reactors, gas-phase reactors, solution reactors, or any combination thereof. Gas phase reactors may comprise fluidized bed reactors or tubular reactors. Slurry reactors may comprise vertical loops or horizontal loops. Solution reactors may comprise stirred tank or autoclave reactors.

Polymerization reactors suitable for the present invention may comprise at least one raw material feed system, at least one feed system for catalyst or catalyst components, at least one reactor system, at least one polymer recovery system or any suitable combination thereof. Suitable reactors for the present invention further may comprise any one, or combination of, a catalyst storage system, an extrusion system, a cooling system, a diluent recycling system, or a control system. Such reactors may comprise continuous take-off and direct recycling of catalyst, diluent, and polymer. Generally, continuous processes may comprise the continuous introduction of a monomer, a catalyst, and a diluent into a polymerization reactor and the continuous removal from this reactor of a suspension comprising polymer particles and the diluent.

Polymerization reactor systems of the present invention may comprise one type of reactor per system or multiple reactor systems comprising two or more types of reactors operated in parallel or in series. Multiple reactor systems may comprise reactors connected together to perform polymerization or reactors that are not connected. The polymer may be polymerized in one reactor under one set of conditions, and then transferred to a second reactor for polymerization under a different set of conditions.

According to one aspect of the invention, the polymerization reactor system may comprise at least one loop slurry reactor. Such reactors are known in the art and may comprise vertical or horizontal loops. Such loops may comprise a single loop or a series of loops. Multiple loop reactors may comprise both vertical and horizontal loops. The slurry polymerization is typically performed in an organic solvent that can disperse the catalyst and polymer. Examples of suitable solvents include butane, hexane, cyclohexane, octane, and isobutane. Monomer, solvent, catalyst and any comonomer may be continuously fed to a loop reactor where polymerization occurs. Polymerization may occur at low temperatures and pressures. Reactor effluent may be flashed to remove the solid resin.

According to yet another aspect of this invention, the polymerization reactor may comprise at least one gas phase reactor. Such systems may employ a continuous recycle stream containing one or more monomers continuously cycled through the fluidized bed in the presence of the catalyst under polymerization conditions. The recycle stream may be withdrawn from the fluidized bed and recycled back into the reactor. Simultaneously, polymer product may be withdrawn from the reactor and new or fresh monomer may be added to replace the polymerized monomer. Such gas phase reactors may comprise a process for multi-step gas-phase polymerization of olefins, in which olefins are polymerized in the gaseous phase in at least two independent gas-phase polymerization zones while feeding a catalyst-containing polymer formed in a first polymerization zone to a second polymerization zone.

According to still another aspect of the invention, the polymerization reactor may comprise a tubular reactor. Tubular reactors may make polymers by free radical initiation, or by employing the catalysts typically used for coordination polymerization. Tubular reactors may have several zones where fresh monomer, initiators, or catalysts are added. Monomer may be entrained in an inert gaseous stream and introduced at one zone of the reactor. Initiators, catalysts, and/or catalyst components may be entrained in a gaseous stream and introduced at another zone of the reactor. The gas streams may be intermixed for polymerization. Heat and pressure may be employed appropriately to obtain optimal polymerization reaction conditions.

According to yet another aspect of the invention, the polymerization reactor may comprise a solution polymerization reactor. During solution polymerization, the monomer is contacted with the catalyst composition by suitable stirring or other means. A carrier comprising an inert organic diluent or excess monomer may be employed. If desired, the monomer may be brought in the vapor phase into contact with the catalytic reaction product, in the presence or absence of liquid material. The polymerization zone is maintained at temperatures and pressures that will result in the formation of a solution of the polymer in a reaction medium. Agitation may be employed during polymerization to obtain better temperature control and to maintain uniform polymerization mixtures throughout the polymerization zone. Adequate means are utilized for dissipating the exothermic heat of polymerization. The polymerization may be effected in a batch manner, or in a continuous manner. The reactor may comprise a series of at least one separator that employs high pressure and low pressure to separate the desired polymer.

According to a further aspect of the invention, the polymerization reactor system may comprise the combination of two or more reactors. Production of polymers in multiple reactors may include several stages in at least two separate polymerization reactors interconnected by a transfer device making it possible to transfer the polymers resulting from the first polymerization reactor into the second reactor. The desired polymerization conditions in one of the reactors may be different from the operating conditions of the other reactors. Alternatively, polymerization in multiple reactors may include the manual transfer of polymer from one reactor to subsequent reactors for continued polymerization. Such reactors may include any combination including, but not limited to, multiple loop reactors, multiple gas reactors, a combination of loop and gas reactors, a combination of autoclave reactors or solution reactors with gas or loop reactors, multiple solution reactors, or multiple autoclave reactors.

The polymerization generally may be conducted at a temperature from about 60° C. to about 280° C., for example, from about 80° C. to about 110° C. According to one aspect of the present invention, the polymerization may be conducted at a temperature from about 85° C. to about 95° C.

The polymerization may be conducted in the presence of one or more optional cocatalysts. The present invention contemplates a first cocatalyst comprising a trialkylboron compound. The alkyl groups of the trialkylboron cocatalyst may have from 1 to about 10 carbon atoms, for example, from 2 to about 4 carbon atoms. Examples include, but are not limited to, triethylboron, tripropylboron, and trimethylboron. The amount of trialkylboron compound used in the polymerization generally may be from about 0.01 parts per million (ppm) to about 20 ppm by weight based on the weight of the diluent in the reactor. According to one aspect of the present invention, the amount of trialkylboron compound may be from about 0.05 ppm to about 10 ppm by weight based on the weight of the diluent in the reactor. According to another aspect of the present invention, the amount of trialkylboron compound may be from about 0.5 ppm to about 8 ppm by weight based on the weight of the diluent in the reactor.

The present invention further contemplates a second cocatalyst comprising a trialkylaluminum compound. The alkyl groups of the trialkylaluminum cocatalyst typically may have from 1 to about 10 carbon atoms, for example, from 2 to about 4 carbon atoms. Examples of trialkylaluminum compounds include, but are not limited to, triethylaluminum, tripropylaluminum, and trimethylaluminum The amount of trialkylaluminum used in the polymerization generally may be from about 0.01 ppm to about 20 ppm by weight based on the weight of the diluent in the reactor. According to one aspect of the present invention, the amount of trialkylaluminum may be from about 0.05 ppm to about 10 ppm by weight based on the weight of the diluent in the reactor. According to another aspect of the present invention, the amount of trialkylaluminum may be from about 0.5 to about 8 ppm by weight based on the weight of the diluent in the reactor.

Hydrogen generally may be present in the polymerization zone in an amount of from about 0.5 to about 3 mole percent based on the moles of diluent. According to one aspect of the present invention, hydrogen may be present in the polymerization zone in an amount of from about 0.8 to about 2.5 mole percent based on the moles of diluent. According to another aspect of the present invention, hydrogen may be present in the polymerization zone in an amount of from about 1.2 to about 2.2 mole percent based on the moles of diluent.

The polymers produced according to the present invention feature an outstanding balance of physical properties. The high load melt index (HLMI) of polymers produced in accordance with the present invention typically may be from about 0.5 to about 20 g/10 minutes. According to one aspect of the present invention, the HLMI may be from about 1 to about 10 g/10 minutes. According to another aspect of the present invention, the HLMI of the polymer product may be from about 2 to about 7 g/10 minutes.

The polymers of this invention also feature a very narrow density range, typically from about 0.945 to about 0.955 g/cc. According to one aspect of the present invention, the density of the polymer may be from about 0.947 to about 0.953 g/cc. According to another aspect of the present invention, the density of the polymer may be from about 0.948 to about 0.952 g/cc.

The HLMI/MI of the polymers of this invention typically may be from about 100 to 1000. According to one aspect of the present invention, the HLMI/MI may be from about 120 to about 500. According to another aspect of the present invention, the HLMI/MI may be from about 150 to about 300. The HLMI/MI ratio tends to increase with molecular weight.

Generally, polymers produced according to the present invention have a PENT ESCR value of greater than about 750 hours, According to one aspect of the present invention, the PENT ESCR value may be greater than about 1000 hours. According to another aspect of the present invention, the PENT ESCR value may be greater than about 1500 hours. According to yet another aspect of the present invention, the PENT ESCR value may be greater than about 2000 hours.

The polymers feature a broad molecular weight distribution as evidenced by the polydispersity index, defined as the weight average molecular weight divided by number average molecular weight (M_{w}/Mₙ). The polydispersity index for polymers produced in accordance with this invention typically may be at least about 40. According to one aspect of the present invention, the polydispersity index may be at least about 50. According to another aspect of the present invention, the polydispersity index may be at least about 60. According to still another aspect of the present invention, the polydispersity index may be at least about 80.

The branch distribution of the polymers produced according to the present invention typically is a flat or rising profile with increasing molecular weight. In general, the branch distribution is characterized by having a high concentration of branching in a molecular weight range of greater than one million, while having little or no branching at molecular weights less than 10,000. As used in this disclosure, the term “SCB/1000 total carbons” refers to short chain branches, such as butyl branches, per one thousand total carbon atoms.

Polymers produced in accordance with this invention generally may have at least about 0.5 short chain branches per thousand total carbons (SCB/1000 total carbons) at one million molecular weight (MW). According to one aspect of the present invention, the polymer may have at least about 1 SCB/1000 total carbons at one million molecular weight (MW). According to another aspect of the present invention, the polymer may have at least about 1.5 SCB/1000 total carbons at one million molecular weight (MW).

The polymers also are characterized as having a high concentration of branching in the molecular weight range of greater than ten million. Polymers produced in accordance with this invention generally have at least about 0.5 short chain branches per thousand total carbons (SCB/1000 total carbons) at ten million MW. According to one aspect of the present invention, the polymer may have at least about 1 SCB/1000 total carbons at ten million MW. According to another aspect of the present invention, the polymer may have at least about 1.5 SCB/1000 total carbons at ten million MW.

Polymers produced in accordance with this invention generally have less than about 1.5 short chain branches per 1000 carbons at 10,000 MW. According to one aspect of the present invention, the polymer may have less than about 1.0 branch per 1000 carbons at 10,000 MW. According to another aspect of the present invention, the polymer may have less than about 0.5 branch per 1000 carbons at 10,000 MW.

Polymers produced in accordance with this invention generally have fewer than 1.5 short chain branches per 1000 carbons at 1000 MW. According to one aspect of the present invention, the polymer may have less than about 1.0 branch per 1000 carbons at 1000 MW. According to another aspect of the present invention, the polymer may have less than about 0.5 branch per 1000 carbons at 1000 MW.

Polymers produced in accordance with this invention are also distinguished by having a branch profile that, unlike Ziegler based bimodal resins, shows no sign of decreasing with increasing molecular weight, even at high molecular weights, such as 10,000,000.

The rheology, or flow behavior in the molten state, of the polymers produced according to the present invention is also unique. Despite the extremely broad molecular weight distribution, these polymers typically have a narrow distribution of relaxation times, as indicated by the Carreau-Yasuda “a” parameter (called CY-a). A high CY-a value in combination with a broad MW distribution indicates a highly linear polymer, low or lacking in long chain branching. This provides a beneficial combination of the physical properties of a high molecular weight polymer with a minimum resistance to flow for the specified molecular weight, as is evidenced by low zero-shear viscosity (called Eta(0)).

The polymers of the present invention typically exhibit a CY-a value of at least about than 0.25. According to one aspect of the present invention, the polymer may have a CY-a value of at least about 0.28. According to another aspect of the present invention, the polymer may have a CY-a value of at least about 0.30. According to yet another aspect of the present invention, the polymer may have a CY-a value of at least about 0.32. As a matter of comparison, chromium-produced resins generally have a broad MW distribution, and a corresponding CY-a value of less than 0.18.

Despite the high molecular weight of the polymers produced according to this invention, they typically exhibit low zero-shear viscosity (Eta(0)). The polymers typically have an Eta(0) value of less than about 5×10⁷ Pa-Sec. According to one aspect of the present invention, the polymer may have an Eta(0) value of less than about 1×10⁷ Pa-Sec. According to another aspect of the present invention, the polymer may have an Eta(0) value of less than about 5×10⁶ Pa-Sec. According to yet another aspect of the present invention, the polymer may have an Eta(0) value of less than about 4×10⁶ Pa-Sec.

Another indication of low levels of long chain branching (which is unusual for chromium derived polymers) is the relaxation time, Tau(eta), calculated from the Carreau-Yasuda equation. A low Tau(eta) value is desirable because it corresponds to minimized stresses in the polymer during molding. Tau(eta) increases with molecular weight. Nevertheless, despite the high molecular weight of the polymers produced according to this invention, they typically exhibit low Tau(eta) values. According to one aspect of the present invention, the polymer may have an Tau(eta) value of less than about 500 seconds. According to another aspect of the present invention, the polymer may have an Tau(eta) value of less than about 200 seconds. According to yet another aspect of the present invention, the polymer may have an Tau(eta) value of less than about 100 seconds. According to still another aspect of the present invention, the polymer may have an Tau(eta) value of less than about 50 seconds.

The ethylene polymers can be used to produce manufactures. The ethylene polymers can be formed into a manufacture by any means known in the art. For example, the ethylene polymers can be formed into a manufacture by blow molding, injection molding, and extrusion molding. Further information on processing the ethylene polymers into a manufacture can be found in MODERN PLASTICS ENCYCLOPEDIA, 1992, pages 222-298.

### D. Pipe Extrusion

The polymers of the present invention are extruded readily into pipe that meets the rigorous standards of the PE-100, MRS 10, or ASTM D3350 typical cell classification 345566C. This includes hoop stress testing and rapid crack propagation, or S4, testing (see ISO/TC 138/SC 4 Parts 1 & 2 Dated 01-01-08).

Pipe extrusion in the simplest terms is performed by melting, conveying polyethylene pellets into a particular shape (generally an annular shape), and solidifying that shape during a cooling process. There are numerous steps to pipe extrusion as provided below. Further information on manufacturing pipe can be found in PLASTICS MATERIALS AND PROCESSES, 1982, pp. 591-592.

The polymer feedstock can either be a pre-pigmented polyethylene resin or it can be a mixture of natural polyethylene and color concentrate (referred to as “salt and pepper blends”). Feedstock is rigidly controlled to obtain the proper finished product (pipe) and ultimate consumer specifications.

The feedstock is then fed into an extruder. The most common extruder system for pipe production is a single-screw extruder. The purpose of the extruder is to melt, convey and homogenize the polyethylene pellets. Extrusion temperatures typically range from about 178° C. to about 232° C., depending upon the extruder screw design and flow properties of the polyethylene.

The molten polymer is then passed through a die. The die distributes the homogenous polyethylene polymer melt around a solid mandrel, which forms it into an annular shape. Adjustments can be made at the die exit to try to compensate for polymer sag through the rest of the process. However, the extent to which these adjustments can be made is limited, particularly when making very large diameter pipes. Therefore, it is highly desirable that the resin be resistant to flow (sag) under low shear conditions (gravity). This is measured rheologically as the zero-shear viscosity, Eta(0) described above. A resin with high Eta(0) will have less tendency to sag. However, if the Eta(0) is too high it leads to high relaxation times (Tau(eta)), and stresses can be frozen into the pipe. Further, it is desirable for the resin to exhibit low viscosity at high shear rates, so that it is less resistant to flow during extrusion. The polymers made according to this invention fulfill all these requirements.

In order for the pipe to meet the proper dimensional parameters, the pipe is then sized. There are two methods for sizing: vacuum or pressure. Both employ different techniques and different equipment.

Next, the pipe is cooled and solidified in the desired dimensions. Cooling is accomplished by the use of several water tanks where the outside pipe is either submerged or water is sprayed on the pipe exterior. The pipe is cooled from the outside surface to the inside surface. The interior wall and inside surfaces of the pipe can stay very hot for a long period of time, as polyethylene is a poor conductor of heat.

Finally, the pipe is printed and either coiled or cut to length. At a sufficiently low temperature there is a critical pressure (Pc), over which one can indefinitely propagate a failure and below which, this breakage will be stopped instantaneously. Similarly, at a certain critical temperature (Tc), there appears a sudden transition in the behavior of the material, from brittle to highly resistant, for which the rapid crack propagation cannot happen for any applied pressure. The critical pressure (Pc) along with the critical temperature (Tc), provides a clear delineation between the propagation and the type of breakage and therefore constitutes the basis to evaluate the behavior of a pipe when being put under any type of pressure (see Leevers, P. S., ASTM 23rd National Symposium on Fracture Mechanics (1991) and Grieg, J. M. Eng.Fracture Mechanics, 42(4), 663-673, (1992)). As a prediction of this transition temperature the laboratory test called “Charpy” was performed according to FS-ISO-13476.

### Examples

In each of the following examples, the following test methods were used:

Density was determined in grams per cubic centimeter (g/cc) on a compression molded sample, cooled at 15° C. per hour, and conditioned for 40 hours at room temperature in accordance with ASTM D1505 and ASTM D1928, procedure C.

High load melt index (HLMI, g/10 min) was determined in accordance with ASTM D1238 at 190° C. with a 21,600 gram weight.

Melt index (MI, g/10 min) was determined in accordance with ASTM D1238 at 190° C. with a 2,160 gram weight.

PENT environmental stress crack resistance values were obtained at 80° C. (176° F.) according to ASTM F1473 (1997).

Tensile strength was determined in accordance with ASTM D 638.

The polydispersity (Mw/Mn) was deterinined using size exclusion chromatography analyses that were performed at 140° C. on a Walters, model 150 GPC with a refractive index detector. A solution concentration of 0.25 weight percent in 1,2,4 trichlorobenzene was found to give reasonable elution times.

Samples for viscosity measurements were compression molded at 182° C. for a total of three minutes. The samples were allowed to melt at a relatively low pressure for one minute and then subjected to a high molding pressure for an additional two minutes. The molded samples were then quenched in a cold (room temperature) press. Discs of 2 mm×25.4 mm diameter were stamped out of the molded slabs for rheological characterization. Fluff samples were stabilized with 0.1 wt % BHT dispersed in acetone and then vacuum dried before molding.

Small-strain oscillatory shear measurements were performed on a Rheometrics Inc. RMS-800 or ARES rheometer using parallel-plate geometry over an angular frequency range of 0.03-100 rad/s. The test chamber of the rheometer was blanketed in nitrogen in order to minimize polymer degradation. The rheometer was preheated to the initial temperature of the study. Upon sample loading and after oven thermal equilibration, the specimens were squeezed between the plates to a 1.6 mm thickness and the excess was trimmed. A total of approximately 8 minutes elapsed between the time the sample was inserted between the plates and the time the frequency sweep was started.

Strains were generally maintained at a single value throughout a frequency sweep but larger strain values were used for low viscosity samples to maintain a measurable torque. Smaller strain values were used for high viscosity samples to avoid overloading the torque transducer and to keep within the linear viscoelastic limits of the sample. The instrument automatically reduces the strain at high frequencies if necessary to keep from overloading the torque transducer.

These data were fit to the Carreau-Yasuda equation to determine zero shear viscosity (η0), relaxation time (τ), and a measure of the breadth of the relaxation time distribution (CY-a). See R. Byron Bird, Robert C. Armstrong, and Ole Hassager, Dynamics of Polymeric Liquids, Volume 1, Fluid Mechanics, (John Wiley & Sons, New York, 1987).

Typical molecular weights and molecular weight distributions were obtained using a Waters 150 CV size exclusion chromatograph (SEC) with trichlorobenzene (TCB) as the solvent, with a flow rate of 1 mL/minute at a temperature of 140° C. (284° F.). BHT (2,6-di-tert-butyl-4-methylphenol) at a concentration of 1.0 g/L was used as a stabilizer in the TCB. An injection volume of 220 μL was used with a polymer concentration of 1.4 mg/L (at room temperature). Dissolution of the sample in stabilized TCB was carried out by heating at 160-170° C. (320-338° F.) for 4 hours with occasional, gentle agitation. The column was two Waters HMW-6E columns (7.8×300 mm) and were calibrated with a broad linear polyethylene standard (Marlex® BHB 5003) for which the molecular weight had been determined. As a measure of volatile oligomeric components, or smoke, the amount of material found in the range of molecular weights from 100 to 1000 were listed.

SEC-FTIR Branch Determination as a function of the molecular weight distribution was obtained as follows. For molecular weight determinations, a Polymer Laboratories model, 210 GPC equipped with two Styragel HT 6E columns (Waters), was used. Resin samples were dissolved in trichlorobenzene (TCB) containing 0.034 weight percent butylatedhydroxytoluene (BHT) by heating the mixture for 1 hour at 155° C. (311° F.) in a Blue M air convection oven. Resin samples of about 1.8 mg/mL were chromatographed at 1 mL/min using TCB as the mobile, at a sample injection volume of 500 μL. The samples were introduced to a Perkin Elmer Model 2000 FTIR spectrophotometer equipped with a narrow band mercury cadmium telluride (MCT) detector via a heated transfer line and flow cell (KBr windows, 1 mm optical path, and about 704 cell volume). The temperatures of the transfer line and flow cell were kept at 143+/−1° C. (290+/−1° F.) and 140+/−1° C. (284±/−1° F.), respectively. Background spectra were obtained on the polymer free, solvent filled cell. All of the IR spectra were measured at 8 cm-1 resolutions (16 scans).

Chromatograms were generated using the root mean square (rms) absorbance over the 3000-2700 cm-1 spectral region and molecular weight calculations were made using a broad molecular weight PE standard. Spectra from individual time slices of the chromatogram were subsequently analyzed for co-monomer branch levels using the Chemometric techniques described below.

Narrow molecular weight distribution samples (Mw/Mn) of about 1.1 to about 1.3, solvent gradient fractions of ethylene 1-butene, ethylene 1-hexene, ethylene 1-octene copolymers, and polyethylene homopolymers were used in calibration and verification studies. Low molecular weight alkanes were also used. The total methyl content of these samples contained from about 1.4 to about 83.3 methyl groups per 1000 total carbon molecules. The methyl content of the samples was calculated from Mn (number average molecular weight) or was measured using C-13 NMR spectroscopy. C-13 NMR spectra were obtained on 15 weight percent samples in TCB using a 500 MHZ Varian Unity Spectrometer at 125° C. (257° F.) as described in J. C. Randall and E. T. Hsieh; NMR and Macromolecules; Sequence, Dynamic, and Domain Structure, ACS Symposium Series 247, J. C. Randall, Ed., American Chemical Society, Washington D.C., 1984. Methyl content per 1000 carbon molecules by NMR was obtained by multiplying the ratio of branching signals to total signal intensity by 1000.

A calibration curve was generated using Pirovette Chemometric software to correlate changes in the FTIR absorption spectra with calculated or NMR measured values for number of methyl groups per 1000 carbon molecules for the samples. The calibration results were obtained for the spectral region of 3000 cm-1 and 2700 cm-1 to avoid the solvent interference in quantitative results for prediction of the measured sample spectrum. Preprocessing of the spectral data included smoothing of 9 data points, baseline correction, and normalization. Further preprocessing of the spectral data entailed taking the first derivative of the spectra and mean centering all the data. A four component calibration model was calculated and optimized using the process of cross validation (RSQ=0.999, SEV=0.7). The calibration model was verified using 13 additional samples. The predicted versus actual values for the validation data showed excellent correlation (RSQ=0.987) and exhibited a root mean square error of prediction equal to +/−0.4 methyl groups per 1000 total carbon molecules.

Short chain branching levels were calculated by subtracting out methyl chain end contributions. The amount of methyl chain ends were calculated using the equation Mece=C(2-Vce)/M, where Mece is the number of methyl chain ends per 1000 total carbon molecules, C is a constant equal to 14000, Vice is the number of vinyl terminated chain ends (1 for chromium catalyzed resins), and M is the molecular weight calculated for a particular slice of the molecular weight distribution.

### Example 1

The polymer was prepared in a continuous, particle form process by contacting a catalyst system with ethylene and 1-hexene. A liquid full about 15.2 cm diameter pipe loop reactor having a volume of about 87 liters was utilized. Isobutane was used as the diluent. Hydrogen was employed. The reactor was operated to have a residence time of about 1.25 hours.

The following feedstocks were utilized in the polymerization runs: ethylene that was dried over alumina was used as a monomer; isobutane that was degassed by fractionation and dried over alumina was used as the diluent; and triethylboron or triethylaluminum was also sometimes used as a cocatalyst, as indicated below.

The first component of the catalyst system was added through a 0.35 cc circulating ball-check feeder, and the second component of the catalyst system was added simultaneously to the reactor through a separate 0.08 cc ball check feeder. The first component and the second component described above were introduced into the reactor simultaneously at a temperature of about 88° C. The first component was fed at the rate of about 80 discharges per hour and the second component at the rate of about 6 discharges per hour. When corrected for activity differences between the first and second components, this corresponds to a ethylene polymer contribution of about 65% from the first component and about 35% from the second component.

Isobutane was fed to the reactor at a rate of about 63.23 lbs per hour, and ethylene was fed at about 28.8 lbs per hour to maintain a reactor concentration of about 10.06 mole percent based on the diluent. Hydrogen concentration was held at about 1.923 mol percent. 1-Hexene was fed to the reactor at about 3.24 lbs per hour in order to hold a concentration in the diluent of about 2.677 mole percent.

The cocatalyst consisted of a mixture of triethyl boron and triethyl aluminum, and it was pumped into the reactor at a rate equal to about 1.30 and about 5.34 ppm based on the weight of the diluent. The reactor residence time was about 1.14 hours. The slurry consisted of about 74.5 percent liquid diluent and about 25.5 percent solid polymer. The total reactor pressure was about 590 psig.

The reactor temperature was set at about 88° C., depending on the particular polymerization run, and the pressure was about 4.1 Mpa (590 psig). The ethylene polymer was removed from the reactor and recovered in a flash tank. A Vulcan dryer was used to dry the ethylene polymer under nitrogen at about 60° C. to about 80° C.

The first component was made from a commercially available alumina obtained from AKZO Nobel as Ketjen Grade L alumina, which contained about 2% silica. The alumina had a pore volume by water adsorption of about 2.1 cc/gm and a surface area of about 350 square meters per gram after calcining at about 600° C. Chromium was added to this alumina, along with a fluorine-containing compound, to form the first component of the catalyst system. This was accomplished by impregnating the support to incipient wetness (or somewhat less) with a methanol solution of chromium (III) nitrate containing about 0.5 g Cr/100 ml. The chromium containing support was then dried under vacuum for about 8 hours at about 110° C. The chromium containing support then was treated with a methanol solution of ammonium bifluoride before being dried again under vacuum at about 110° C. to produce the first component. The first component of the catalyst system contained about 2 wt % Cr and about 6 wt % ammonium bifluoride based on the weight of the support. The first component was then activated by calcining at about 590° C. in dry air in a fluidized bed for 6 hours, then cooled in nitrogen to about 370° C., then exposed to carbon monoxide for two hours, followed by flushing with pure nitrogen for about 30 minutes, and finally, cooled to room temperature and stored under nitrogen.

The second component of the catalyst system was prepared according to U.S. Pat. No. 4,325,837. In particular, the second component was prepared by contacting magnesium dichloride and titanium ethoxide in xylene to obtain a solution, then contacting the solution with ethyl aluminum dichloride to obtain a solid, then contacting the solid with ethylene to obtain a prepolymerized solid, and then contacting the resulting prepolymerized solid with titanium tetrachloride to form the second component. The second component contained about 10 wt % titanium and about 10 wt % prepolymer. The second component then was treated with a heptane solution of triethyl aluminum (TEA) containing enough TEA to equal about 0.6 mole of aluminum for each mole of titanium in the catalyst. A fumed silica sold by Cabot Corporation under the name HS-5 was added to the second component. The fumed silica was added as an anti-caking agent as described in U.S. Pat. No. 5,179,178 in the amount of about 15 wt % based on the weight of the second component of the catalyst system.

The ethylene polymer produced was analyzed, and the results are summarized in Table 1. The ethylene polymer produced was compared to TR-480 and high density TR480, standard high quality, pipe resins sold commercially by Performance Pipe, a division of Chevron Phillips Chemical Company, LP.

TABLE 1

| | Example | | |
|---|---|---|---|
| | | | High Density |
| | Inventive | TR480 | TR480 |
| HLMI | 11.5 | 12 | 7 |
| HLMI/MI | 550 | 110 | 128 |
| Density | 0.9499 | 0.944 | 0.949 |
| Tensile strength (psi) | 3500 | 3250 | 3459 |
| PENT (hrs) | >2600 | 112 | 53 |
| Mw/1000 | 451 | 237 | 220 |
| Mn/1000 | 7.3 | 12.9 | 13.5 |
| Mw/Mn | 61.7 | 18.3 | 16.3 |
| Eta(0) | 3.02E+06 | 1.63E+06 | 3.10E+06 |
| CY-a | 0.3316 | 0.1616 | 0.174 |
| Tau(eta) | 48.3 | 4.9 | 14.7 |

The resin produced according to the present invention has a higher tensile strength than TR-480. The increased tensile strength is likely attributable to the higher density of the inventive resin. These results were achieved without adversely impacting other pipe properties, as would be normally expected. The resin produced according to the present invention thus provides significant advantages over commercially available resins.

### Example 2

The procedures of Example 1 were repeated except that the catalyst first component was impregnated with a methanol solution of phosphoric acid and ammonium bifluoride to contain P/Al molar ratio of about 0.03 and about 3% fluoride. Other materials were unchanged. The catalyst was then activated in air at about 600° C., but it was not reduced in carbon monoxide. Polymers were then made in the same 23-gallon reactor under similar conditions to that described in Example 1 using hydrogen and triethylaluminum along with hexene and ethylene feedstocks. The results from this series of tests are shown in Table 2.

TABLE 2

| Example | Mn/1000 | Mw/1000 | Mw/Mn | Eta(0) | Tau(eta) | CY-a | MI | HLMI | HLMI/MI | Density |
|---|---|---|---|---|---|---|---|---|---|---|
| 2A | 6.9 | 674.8 | 97.7 | 2.98E+06 | 47.5 | 0.3470 | 0.010 | 3.69 | 365.3 | 0.9487 |
| 2B | 6.8 | 649.7 | 95.5 | 2.44E+06 | 44.4 | 0.3298 | 0.015 | 6.31 | 410.3 | 0.9501 |
| 2C | 7.5 | 698.5 | 92.6 | 2.77E+06 | 44.9 | 0.3408 | 0.012 | 3.86 | 334.5 | 0.9497 |
| 2D | 7.5 | 648.5 | 86.0 | 3.89E+06 | 62.5 | 0.2998 | 0.020 | 4.57 | 228.5 | 0.9489 |

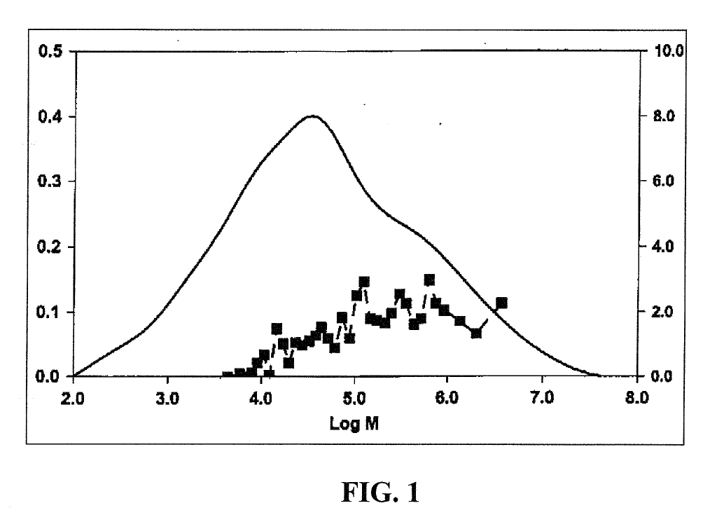

A branch profile of the resin prepared in Example 2B was conducted via FTIR-GPC according to the procedure described above. The result is shown in FIG. 1, in which the MW distribution (continuous line) and the short chain branching level (points) are plotted. The SCB scale is shown on the right axis in branches per 1000 carbons. It can be seen that the molecular weight distribution is exceptionally broad and that the branches are concentrated in the high molecular weight portion of the distribution. Furthermore, unlike Ziegler-based bimodals from multiple reactor arrangements, there is no indication of the branch concentration decreasing at the very high molecular weight regions, such as 10,000,000 and up. In other tests conducted on resins obtained from the high MW catalyst alone (component 1), it is clear that this branch profile is not decreasing even at 10,000,000 molecular weight or higher.

### Example 3

The same polymerization reactor and similar conditions were employed to prepare additional polymers. However, several different catalyst types were used. These results are shown in Table 3. Various physical properties that are indicators of pipe performance were evaluated. For example, high PENT, for example, above 500 hours, is an indication of good slow crack resistance in pipe, and a low Charpy transition temperature, for example, below 0° C.} is an indication of good rapid crack growth resistance due to low temperature embrittlement.

TABLE 3

| Example | 3A | 3B | 3C | 3D | 3E | 3F |
|---|---|---|---|---|---|---|
| Cr Catalyst | 967BWFl | Cr/FP- | Cr/FP- | Cr/FP- | Cr/FP- | Cr/FP- |
| | | Alumina | Alumina | Alumina | Alumina | Alumina |
| ZN Catalyst | Sylopol 5951 | Lynx 100 | Lynx 100 | Sylopol 5951 | Sylopol 5951 | Sylopol 5951 |
| Cr Act. Temp, ° F. | 950 | 1100 | 1100 | 1100 | 1100 | 1100 |
| Cr feeding | 67 | 255 | 260 | 169 | 171 | 14 |
| ZN feeding | 37 | 425 | 300 | 260 | 272 | 216 |
| Rxn Temp, ° C. | 90 | 88.1 | 88.1 | 90 | 90 | 90 |
| Ethylene, wt % | 4.6 | 3.1 | 3.5 | 5.1 | 5 | 5.1 |
| Hexene, wt % | 0.98 | 0.86 | 1.04 | 1.67 | 1.25 | 1.08 |
| Hydrogen, vol % | 0.98 | 1.02 | 1.09 | 0.84 | 0.86 | 0.56 |
| TEA, ppm | 30 | 10 | 10 | 30 | 30 | 30 |
| Solids, % | 42 | 35 | 34 | 40 | 41 | 41 |
| % Fines, <180° | 14.6 | — | — | 21.5 | 19 | 16.3 |
| HLMI, fluff | 8.3 | 2.94 | 2.7 | 4.1 | 6.5 | 7.6 |
| Density, g/cc | 0.9501 | 0.9503 | 0.9498 | 0.9491 | 0.9507 | 0.9533 |
| NMR, % Hex, mol | 0.32 | 0.26 | 0.28 | 0.45 | 0.29 | 0.25 |
| GPC, Mw (10³) | 323.3 | 494.5 | 560 | 508.8 | 478.7 | 502.3 |
| GPC, Mn (10³) | 9.5 | 7.7 | 11 | 8 | 8.9 | 8.5 |
| Mw/Mn | 34 | 64.2 | 50.9 | 63 | 54 | 59 |
| Flex. Mod., MPa | — | 954 | 965 | 783 | 884 | — |
| PENT, h | 20 | >626 | >626 | >750 | >750 | >750 |
| Charpy | | | | | | |
| Critical Temp, ° C. | −13.4 | −30.5 | −30.5 | −21.7 | −22.8 | −21.7 |
| Total Energy at | 80 | 295 | 337 | 184 | 173 | 119 |
| 23° C., J/m | | | | | | |

The resin of Example 3A, the control example, was prepared using a Cr/silica-alumina catalyst as component 1 to produce the high MW portion of the resin. The catalyst used is commercially available from W. R. Grace under the trade name 967BWFl, and is believed to contain about 1% Cr on a silica-alumina base containing about 13% alumina, and about 2% fluoride from ammonium silicofluoride. The catalyst used as the second component to produce the low MW portion of the resin was SYLOPOL 5951, commercially available from W. R. Grace (Columbia, Md.). SYLOPOL 5951 is a titanium-magnesium chloride based Ziegler catalyst that is supported on silica. Based on the high Charpy transition temperature and the low PENT values exhibited by this resin, it is evident that this catalyst system does not produce a polymer that is suitable for use in a pipe.

In examples 3B-3F, a Cr/alumina catalyst containing phosphate and fluoride (used in Example 2) was used for component 1 of the catalyst system. Either the LYNX-100 catalyst (used in Examples 1 & 2) or the SYLOPOL 5951 (used in Example 3A) was used as component 2 in the catalyst system. All of the resins produced exhibited outstanding physical properties and an extremely broad MW distribution, as indicated by Mw/Mn.

The resin formed in Example 3E was selected for additional testing. Example resin 3E was extruded into 2-inch SDR-11 pipe and tested for hoop stress (slow crack growth) under three different conditions, varying in temperature and pressure applied. Despite the very high MW, these resins processed into pipe quite easily, and with less than the typical extruder back pressure. The ability to process the resin despite its high MW is likely attributable to the extremely broad MW distribution and shear thinning behavior of the resin. The hoop stress test pressurizes several pipe samples at specified temperatures and pressures and waits until these samples fail. The longer the sample sustains before failure, the better its performance. The conditions utilized are standard evaluations needed for PE-100 pipe certification. The required PE-100 qualification values for the three conditions are 100, 165, and 1000 hours, respectively. The results are set forth in Table 4.

TABLE 4

| | |
|---|---|
| HLMI | 6.5 |
| Density, g/cc | 0.951 |
| Charpy | |
| Critical Temp, ° C. | −22.8 |
| Total Energy at 23° C., J/m | 173 |
| PENT, h | |
| 2.4 MPa, 80° C. | >2000 |
| Hoop Stress | |
| 20° C., 12.4 MPa | 160 |
| 80° C., 5.5 MPa | >2000 |
| 80° C., 5.0 MPa | >2000 |

As is evident from the results presented above, the Example 3E resin exhibited good Charpy values and an extremely high PENT value. The hoop stress values significantly exceed the requirements for PE-100 pipe. The hoop stress test was stopped after 2000 hours with no breaks. Thus it is clear that these resins exhibit exceptional resistance to hoop stress failure.

1. A process for polymerizing olefins in the presence of a catalyst composition, comprising:
contacting the catalyst composition with at least one olefin monomer under polymerization conditions to produce a polymer, wherein the catalyst composition comprises:
(a) a first component comprising chromium on a support, wherein the support comprises phosphated alumina; and
(b) a second component comprising:
(1) the contact product of:
i) a metal halide compound, wherein the metal halide compound is a metal dihalide compound or a metal hydroxyhalide compound of a Group IIA or Group IIB metal of the Mendeleev Periodic Table;
ii) a transition metal compound, wherein the transition metal compound comprises a transition metal of Group IVB or Group VB of the Mendeleev Periodic Table, and wherein the transition metal compound comprises at least one hydrocarbyl oxide ligand, at least one hydrocarbyl amide ligand, at least one hydrocarbyl imide ligand, or at least one hydrocarbyl thiolate ligand; and
iii) a precipitating agent, wherein the precipitating agent is an organometallic compound of a Group I, II, or III metal of the Mendeleev Periodic Table; a metal halide or a metal oxyhalide of a Group IIIA, IVA, IVB, VA, or VB metal of the Mendeleev Periodic Table; a hydrogen halide; or an organic acid halide RC(O)X, wherein R is an alkyl, an aryl, a cycloalkyl, or a combination thereof having from 1 to about 12 carbon atoms, and X is a halogen atom; or
(2) a substituted or unsubstituted dicyclopentadienyl chromium compound deposited onto a calcined oxide carrier, wherein the carrier comprises silica, alumina, aluminophosphate, or any mixture or mixed oxide thereof.

2. The process of claim 1, wherein the support further comprises fluoride.

3. The process of claim 1, wherein the second component further comprises an anti-caking agent.

4. The process of claim 1, wherein the catalyst system further comprises a first cocatalyst comprising a trialkyl boron compound.

5. The process of claim 1, wherein the catalyst system further comprises a second cocatalyst comprising a trialkylaluminum compound.

6. The process of claim 1, wherein the second component further comprises a halide ion exchanging source.

7. The process of claim 6, wherein the halide ion exchanging source is titanium tetrachloride, titanium tetrabromide, vanadium oxychloride, or zirconium tetrachloride.

8. The process of claim 1, wherein the catalyst composition and the at least one olefin monomer are contacted in a gas phase reactor, a loop reactor, or a stirred tank reactor.
